(19) United States
(12) Patent Application Publication
(10) Pub. No.: US 2021/0278007 A1
(43) Pub. Date: Sep. 9, 2021

(54) SOLENOID

(71) Applicant: DENSO CORPORATION, Kariya-city (JP)

(72) Inventors: Kazuhiro SASAO, Kariya-city (JP); Yutaro WATARI, Kariya-city (JP)

(21) Appl. No.: 17/327,213

(22) Filed: May 21, 2021

Related U.S. Application Data
(63) Continuation of application No. PCT/JP2019/045573, filed on Nov. 21, 2019.

(30) Foreign Application Priority Data
Nov. 26, 2018 (JP) 2018-219984

(51) Int. Cl. F16K 31/06; H01F 7/16; H01F 7/08

(52) U.S. Cl. CPC F16K 31/0613; H01F 7/081; H01F 7/1607

(57) ABSTRACT

A solenoid includes a coil, a plunger, a yoke, and a stator core. The yoke includes a side wall and a bottom. The stator core includes a magnetic attraction core, a slide core, and a magnetic flux passage restricting portion. The slide core includes: a core portion formed in a tubular shape; and a first magnetic flux transmitting portion configured to transmit magnetic flux between the yoke and the plunger through the core portion. The magnetic flux passage restricting portion is configured to restrict passage of the magnetic flux between the slide core and the magnetic attraction core. A second magnetic flux transmitting portion is configured to transmit the magnetic flux between the magnetic attraction core and the side wall. An elastic member is arranged in contact with an end surface of the magnetic attraction core and is configured to bias the stator core toward the bottom.

### CROSS REFERENCE TO RELATED APPLICATIONS

The present application is a continuation application of International Patent Application No. PCT/JP2019/045573 filed on Nov. 21, 2019, which designated the U.S. and claims the benefit of priority from Japanese Patent Applications No. 2018-219984 filed on Nov. 26, 2018. The entire disclosures of all of the above applications are incorporated herein by reference.

### TECHNICAL FIELD

The present disclosure relates to a solenoid.

### BACKGROUND

A known solenoid includes a coil which generates magnetic force by energization, a stator core arranged radially inside the coil, and a plunger which slides on an inner peripheral side of the stator core.

### SUMMARY

According to an aspect of the present disclosure, a solenoid is provided. The solenoid includes a coil, a plunger, a yoke, and a stator core. The plunger formed in a columnar shape is arranged radially inside the coil and is configured to slide in an axial direction. The yoke houses the coil and the plunger and includes: a side wall provided along the axial direction; and a bottom provided along a direction that intersects the axial direction and opposed to a base end surface of the plunger. The stator core includes a magnetic attraction core, a slide core, and a magnetic flux passage restricting portion. The magnetic attraction core is opposed to a front end surface of the plunger in the axial direction. The slide core includes: a core portion formed in a tubular shape and arranged radially outside the plunger; and a first magnetic flux transmitting portion fixed to an outer peripheral surface of an end portion of the core portion that is opposed to the bottom. A second magnetic flux transmitting portion is arranged radially outside an end portion of the magnetic attraction core located on an opposite side from the plunger in the axial direction. An elastic member is arranged in contact with an end surface of the magnetic attraction core on an opposite side from the plunger in the axial direction.

### BRIEF DESCRIPTION OF DRAWINGS

The above and other objects, features and advantages of the present disclosure will become more apparent from the following detailed description made with reference to the accompanying drawings. In the drawings:

FIG. 1 is a sectional view showing a schematic structure of a solenoid applied to a linear solenoid valve according to a first embodiment.

FIG. 2 is a sectional view showing a detailed structure of the solenoid.

FIG. 3 is a sectional view showing a detailed structure of a solenoid according to a second embodiment.

FIG. 4 is a sectional view showing a compression amount during assembly process.

FIG. 5 is a sectional view showing a detailed structure of a solenoid according to a third embodiment.

FIG. 6 is a sectional view showing a detailed structure of a solenoid according to a fourth embodiment.

FIG. 7 is a sectional view showing a detailed structure of a solenoid according to a fifth embodiment.

FIG. 8 is a sectional view showing a detailed structure of a solenoid according to a sixth embodiment.

FIG. 9 is a sectional view showing a detailed structure of a solenoid according to a seventh embodiment.

### DETAILED DESCRIPTION

A solenoid may include a coil which generates magnetic force by energization, a stator core arranged radially inside the coil, and a plunger which slides on an inner peripheral side of the stator core. In a solenoid, a ring core made of magnetic material is arranged on an outer peripheral side of a stator core. Because of this, magnetic circuit components such as a yoke and the stator core are magnetically coupled through the ring core. Therefore, deterioration of magnetic force due to a gap between the magnetic circuit components and the stator core which are assembled is restricted.

In the solenoid described above, the ring core is movable in a radial direction. Therefore, the ring core may be assembled so as to be eccentric to a slide core, and a size of a gap between the slide core and the ring core may be biased in the radial direction. In this case, distribution of magnetic flux transmitted to the slide core and a plunger through the ring core may be biased in the radial direction, and attractive force in the radial direction may be generated as side force. If the side force is increased, slidability of the plunger may be deteriorated. Therefore, the plunger is desired to be protected from the deterioration of the slidability.

The present disclosure can be implemented in the follow manners.

According to an exemplar embodiment of the present disclosure, a solenoid is provided. The solenoid includes a coil, a plunger, a yoke, and a stator core. The coil is configured to generate magnetic force when energized. The plunger formed in a columnar shape is arranged radially inside the coil and is configured to slide in an axial direction. The yoke houses the coil and the plunger and includes: a side wall provided along the axial direction; and a bottom provided along a direction that intersects the axial direction and opposed to a base end surface of the plunger. The stator core includes a magnetic attraction core, a slide core, and a magnetic flux passage restricting portion. The magnetic attraction core is opposed to a front end surface of the plunger in the axial direction and is configured to magnetically attract the plunger by magnetic force generated by the coil. The slide core includes: a core portion formed in a tubular shape and arranged radially outside the plunger; and a first magnetic flux transmitting portion fixed to an outer peripheral surface of an end portion of the core portion that is opposed to the bottom. The first magnetic flux transmitting portion is configured to transmit magnetic flux between the yoke and the plunger through the core portion. The magnetic flux passage restricting portion is configured to restrict passage of the magnetic flux between the slide core and the magnetic attraction core. A second magnetic flux transmitting portion is arranged radially outside an end portion of the magnetic attraction core located on an opposite side from the plunger in the axial direction and is configured to transmit the magnetic flux between the magnetic attraction core and the side wall. An elastic member is arranged in contact with an end surface of the magnetic attraction core on an opposite side from the plunger in the axial direction and is configured to bias the stator core toward the bottom.

In the solenoid described above, the slide core includes the core portion and the first magnetic flux transmitting portion. The core portion has the tubular shape and is arranged radially outside the plunger. The first magnetic flux transmitting portion is fixed to the outer peripheral surface of the end portion of the core portion and is configured to transmit the magnetic flux between the yoke and the plunger through the core portion. That is, a gap between the core portion and the first magnetic flux transmitting portion is not provided in the radial direction. Because of this, distribution of the magnetic flux transmitted from the first magnetic flux transmitting portion to the plunger through the core portion can be restricted from being biased in the radial direction. In addition, generation of side force due to bias of magnetic flux distribution can be restricted. Therefore, slidability of the plunger can be protected from the deterioration. In addition, the elastic member is arranged in contact with the end surface of the magnetic attraction core on the opposite side from the plunger in the axial direction and is configured to bias the stator core toward the bottom. Therefore, the first magnetic flux transmitting portion can be pressed toward the bottom, and a loss in the magnetic flux transmitted from the bottom of the yoke to the first magnetic flux transmitting portion can be restricted. Further, the elastic member is in contact with the end surface of the magnetic attraction core. Therefore, reduction in magnetic efficiency can be restricted as the magnetic efficiency is not affected by the elastic member, compared to a structure in which an elastic member is located around magnetic circuit so as to press the first magnetic flux transmitting portion to the bottom.

The present disclosure can be implemented by various forms. For example, the present disclosure can be implemented in a solenoid valve, manufacturing method for a solenoid, or the like.

### A. First Embodiment

### A-1. Configuration

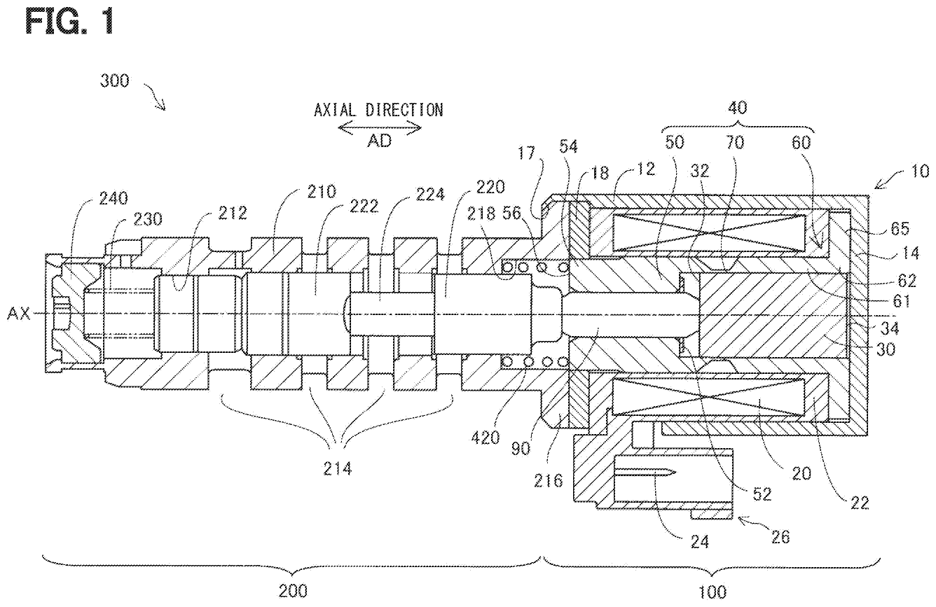

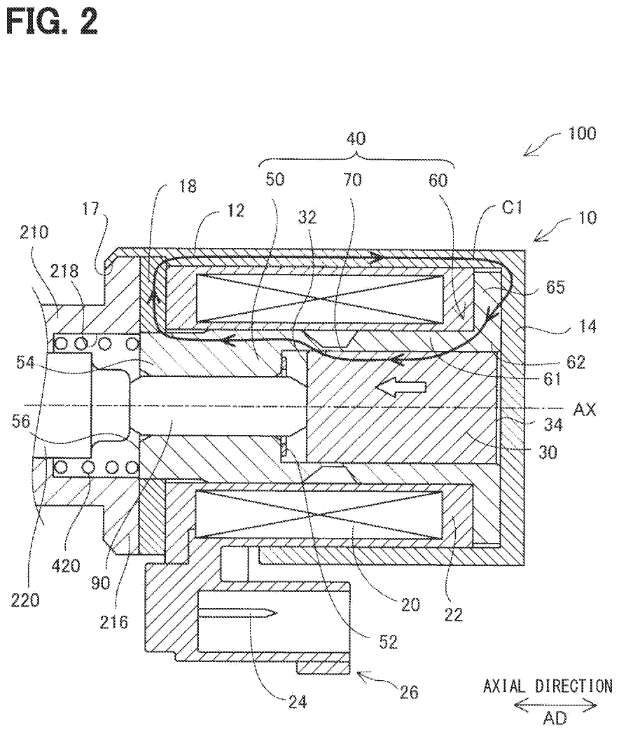

FIG. 1 shows a solenoid 100 in a first embodiment. The solenoid 100 is applied to a linear solenoid valve 300 and functions as an actuator to drive a spool valve 200. The linear solenoid valve 300 is configured to control a hydraulic pressure of hydraulic oil supplied to an unillustrated vehicle automatic transmission and is arranged in an unillustrated hydraulic circuit. The spool valve 200 and the solenoid 100 included in the linear solenoid valve 300 are arranged along a central axis AX. FIGS. 1 and 2 show the solenoid 100 and the linear solenoid valve 300 in a non-energized state. The linear solenoid valve 300 in the present embodiment is a normally closed type. However, the linear solenoid valve 300 may be a normally open type.

The spool valve 200 shown in FIG. 1 controls communication states and opening areas of multiple oil ports 214 which will be described below. The spool valve 200 includes a sleeve 210, a spool 220, a spring 230, and an adjust screw 240.

The sleeve 210 has an appearance of a substantially cylindrical shape. In the sleeve 210, an insertion hole 212 and the multiple oil ports 214 are formed. The insertion hole 212 penetrates along the central axis AX. The oil port 214 is communicated to the insertion hole 212 and opens in a radial direction. The spool 220 is inserted into the insertion hole 212. An end of the insertion hole 212 close to the solenoid 100 has a diameter expanded radially outward and functions as an elastic member housing portion 218. An elastic member 420 which will be described below is housed in the elastic member housing portion 218. The elastic member housing portion 218 is communicated with an outside through an unillustrated breathing hole formed in the sleeve 210. The multiple oil ports 214 are arranged in a direction parallel to the central axis AX, referred to as axial direction AD hereinafter. The multiple oil ports 214 correspond to, for example, an inlet port communicated to an unillustrated oil pump and configured to receive supply of hydraulic pressure, an outlet port communicated to an unillustrated clutch piston and through which the hydraulic pressure is supplied, a drain port through which the hydraulic oil is discharged, or the like. A flange 216 is formed on an end of the sleeve 210 close to the solenoid 100. The flange 216 includes a part which has a diameter expanded radially outward. The flange 216 and a yoke 10 of the solenoid 100 which will be described below are fixed to each other.

The spool 220 has an appearance of a substantially bar shape such that multiple large-diameter portions 222 and a small-diameter portion 224 are arranged along the axial direction AD. The spool 220 slides along the axial direction AD in the insertion hole 212 and controls the communication states and the opening areas of the multiple oil ports 214 corresponding to positions of the large-diameter portions 222 and the small-diameter portion 224 in the axial direction AD. A shaft 90 abuts against one end of the spool 220 and is configured to transmit thrust of the solenoid 100 to the spool 220. The spring 230 is arranged on the other end of the spool 220. The spring 230 includes a compression coil spring and is configured to press the spool 220 in the axial direction AD and to bias the spool 220 toward the solenoid 100. The adjust screw 240 abuts against the spring 230. A spring load of the spring 230 is controlled by adjusting a depth of the adjust screw 240 screwed on the sleeve 210.

Energization of the solenoid 100 shown in FIGS. 1 and 2 is controlled by an unillustrated electronic control unit to drive the spool valve 200. The solenoid 100 includes the yoke 10, a ring member 18, a coil 20, a plunger 30, a stator core 40, and the elastic member 420.

The yoke 10 is made of magnetic metal and forms an outer frame of the solenoid 100 as shown in FIG. 2. The yoke 10 has a tubular shape with a bottom and houses the coil 20, the plunger 30, and the stator core 40. The yoke 10 includes a side wall 12, a bottom 14, and an opening portion 17.

The side wall 12 has a substantially cylindrical shape along the axial direction AD. A thin portion 15 formed in a thin shape is provided on one end of the side wall 12 close to the spool valve 200. The bottom 14 is connected to the other end of the side wall 12 located on an opposite side from the spool valve 200. The bottom 14 is perpendicular to the axial direction AD and closes the end of the side wall 12. The bottom 14 is not limited to being perpendicular to the axial direction AD. The bottom 14 may be substantially perpendicular to the axial direction AD or may intersect the axial direction AD at an arbitrary angle, except for 90°. The bottom 14 is opposed to a base end surface 34 of the plunger 30 which will be described below. The opening portion 17 is formed on the thin portion 15 located on the end of the side wall 12 close to the spool valve 200. The opening portion 17 is fixed to the flange 216 of the spool valve 200 by being plastically deformed after components of the solenoid 100 are assembled in the yoke 10. The spool valve 200 and the yoke 10 may be fixed by an arbitrary fixing method such as welding, not only by plastic deformation.

The ring member 18 is arranged between the coil 20 and the flange 216 of the spool valve 200 in the axial direction AD. In other words, the ring member 18 is arranged radially outside an end portion of a magnetic attraction core 50 of the stator core 40, which will be described below, on an opposite side from the plunger 30 in the axial direction AD. (The end portion of the magnetic attraction core 50 on the opposite side from the plunger 30 is referred to as end portion 54 hereinafter). The ring member 18 has a ring shape and is made of magnetic metal. The ring member 18 is configured to transmit a magnetic flux between the magnetic attraction core 50 of the stator core 40 and the side wall 12 of the yoke 10. The ring member 18 is displaceable in the radial direction. Therefore, dimensional variation of the stator core 40 in manufacturing and axis deviation in assembly are absorbed. In the present embodiment, the magnetic attraction core 50 which will be described below is pressed into the ring member 18. The magnetic attraction core 50 is not limited to be pressed into the ring member 18 and may be fitted to the ring member 18 through a slight gap in the radial direction.

In the coil 20, a lead wire coated with insulation is wound onto a bobbin 22 made of resin. The bobbin 22 is arranged radially inside the side wall 12 of the yoke 10. An end of the lead wire of the coil 20 is connected to a connection terminal 24. The connection terminal 24 is arranged in a connector 26. The connector 26 is arranged in an outer peripheral side of the yoke 10 and electrically connects the solenoid 100 to the electronic control device through an unillustrated connection line. Because of the coil 20, magnetic force is generated by the energization. Additionally, a flow of the magnetic flux, referred to as magnetic circuit hereinafter, is formed so as to loop and pass through the side wall 12 of the yoke 10, the bottom 14 of the yoke 10, the stator core 40, the plunger 30, and the ring member 18. In a state shown in FIGS. 1 and 2, the coil 20 is not energized, and the magnetic circuit is not formed. However, for convenience of explanation, a magnetic circuit C1 formed by the energization to the coil 20 is schematically shown by a thick arrow in FIG. 2.

The plunger 30 has a substantially cylindrical shape and is made of magnetic metal. The plunger 30 slides in the axial direction AD radially inside a core portion 61 of the stator core 40 which will be described below. The shaft 90 abuts against one end surface of the plunger 30 close to the spool valve 200. (The end surface of the plunger 30 close to the spool valve 200 is referred to as front end surface 32 hereinafter). Because of biasing force caused by the spring 230 and transmitted to the spool 220, the plunger 30 is biased toward the bottom 14 of the yoke 10 along the axial direction AD. The other end surface of the plunger 30 on an opposite side of the front end surface 32 is referred to as base end surface 34 hereinafter and is opposed to the bottom 14 of the yoke 10. An unillustrated ventilation hole penetrates the plunger 30 in the axial direction AD. Fluid such as the hydraulic oil and air passes through the ventilation hole between an area close to the base end surface 34 of the plunger 30 and an area close to the front end surface 32 of the plunger 30.

The stator core 40 is made of magnetic metal and is disposed between the coil 20 and the plunger 30. The stator core 40 includes the magnetic attraction core 50, a slide core 60, and a magnetic flux passage restricting portion 70.

The magnetic attraction core 50 surrounds the shaft 90 in a circumferential direction. The magnetic attraction core 50 is a part of the stator core 40 and located close to the spool valve 200. The magnetic attraction core 50 magnetically attracts the plunger 30 by the magnetic force generated by the coil 20. A stopper 52 is arranged on the magnetic attraction core 50 at a surface opposed to the front end surface 32 of the plunger 30. The stopper 52 is made of non-magnetic material and is configured to restrict the plunger 30 and the magnetic attraction core 50 from directly abutting against each other. In addition, the stopper 52 is configured to restrict the plunger 30 from being inseparable from the magnetic attraction core 50 because of the magnetic attraction.

The slide core 60 is a part of the stator core 40 and is located close to the bottom 14. The slide core 60 is arranged radially outside the plunger 30. The slide core 60 includes the core portion 61 and a magnetic flux transmitting portion 65.

The core portion 61 has a substantially cylindrical shape and is disposed between the coil 20 and the plunger 30 in the radial direction. The core portion 61 is configured to guide the plunger 30 to move along the axial direction AD. Therefore, the plunger 30 slides directly on an inner peripheral surface of the core portion 61. An unillustrated sliding gap is provided between the core portion 61 and the plunger 30 to ensure slidability of the plunger 30. An end portion of the slide core 60 on an opposite side from the magnetic attraction core 50 is referred to as end portion 62 hereinafter. The end portion 62 is opposed to the bottom 14 and abuts against the bottom 14.

The magnetic flux transmitting portion 65 expands radially outward from the end portion 62 over an entire circumference of the end portion 62. That is, the magnetic flux transmitting portion 65 is arranged between the bobbin 22 and the bottom 14 of the yoke 10 in the axial direction AD. The magnetic flux transmitting portion 65 is configured to transmit the magnetic flux between the yoke 10 and the plunger 30 through the core portion 61. More specifically, the magnetic flux is transmitted from the bottom 14 of the yoke 10 to the plunger 30 through the magnetic flux transmitting portion 65. The magnetic flux may be transmitted from the side wall 12 of the yoke 10 to the plunger 30 through the magnetic flux transmitting portion 65. In the present embodiment, a gap is provided between the magnetic flux transmitting portion 65 and the side wall 12 of the yoke 10 in the radial direction in order to assemble.

The magnetic flux passage restricting portion 70 is formed between the magnetic attraction core 50 and the core portion 61 in the axial direction AD. The magnetic flux passage restricting portion 70 is configured to restrict the magnetic flux from flowing directly between the core portion 61 and the magnetic attraction core 50. In the present embodiment, a thickness of the magnetic flux passage restricting portion 70 in the radial direction is thinner than those of the other portions included in the stator core 40. Therefore, magnetic resistance of the magnetic flux passage restricting portion 70 is larger than those of the magnetic attraction core 50 and the core portion 61.

The elastic member 420 is housed in the elastic member housing portion 218 formed in the sleeve 210 of the spool valve 200 and biases the stator core 40 toward the bottom 14. The elastic member 420 abuts against an end surface of the magnetic attraction core 50 (referred to as end surface 56 hereinafter) located in an opposite side from the plunger 30 in the axial direction AD. In the present embodiment, the elastic member 420 includes a compression spring formed in a substantially cylindrical shape. The compression spring is made of wire which has a round shape in a cross section. The spool 220 is inserted in the elastic member 420. As the elastic member 420 biases the stator core 40 toward the bottom 14 of the yoke 10 in the axial direction AD, the magnetic flux transmitting portion 65 is pressed toward the bottom 14. Therefore, a loss in the magnetic flux transmitted from the bottom 14 of the yoke 10 to the magnetic flux transmitting portion 65 is restricted.

In the present embodiment, the yoke 10, the bottom 14, the ring member 18, the plunger 30, and the stator core 40 are made of iron. However, the materials of the above elements are not limited to iron and may be arbitrary magnetic material such as nickel or cobalt. In the present embodiment, the elastic member 420 is made of austenitic stainless steel. However, the elastic member 420 may be made of arbitrary non-magnetic material such as aluminum or brass, not only the austenitic stainless steel. Additionally, the elastic member 420 may be made of magnetic material, not the non-magnetic material. In the present embodiment, the yoke 10 is formed by pressing, and the stator core 40 is formed by forging. However, each of the yoke 10 and the stator core 40 may be formed by other arbitrary molding methods.

As shown in FIG. 2, the magnetic circuit C1 passes through the side wall 12 of the yoke 10, the bottom 14 of the yoke 10, the magnetic flux transmitting portion 65 of the stator core 40, the core portion 61 of the stator core 40, the plunger 30, the magnetic attraction core 50 of the stator core 40, and the ring member 18. Therefore, the plunger 30 is attracted toward the magnetic attraction core 50 by the energization to the coil 20. Thereby, the plunger 30 slides in a direction shown by a blank arrow in the axial direction AD, at a location radially inside the core portion 61, in other words, radially inside the slide core 60. In this way, by the energization to the coil 20, the plunger 30 is moved toward the magnetic attraction core 50 against the biasing force of the spring 230. As a current which flows through the coil 20 is large, magnetic flux density of the magnetic circuit is increased, and a stroke amount of the plunger 30 is increased. Here, the stroke amount of the plunger 30 corresponds to an amount in which the plunger 30 is moved along the axial direction AD from a reference point on which the plunger 30 is the farthest from the magnetic attraction core 50 toward the magnetic attraction core 50 in reciprocation of the plunger 30. When the plunger 30 is the farthest from the magnetic attraction core 50, the solenoid 100 is in the non-energized state. On the other hand, unlike FIG. 2, when the plunger 30 is the closest to the magnetic attraction core 50, the coil 20 is energized, and the front end surface 32 of the plunger 30 abuts against the stopper 52. At this point, the stroke amount of the plunger 30 is the largest.

When the plunger 30 is moved toward the magnetic attraction core 50, the shaft 90 which abuts against the front end surface 32 of the plunger 30 presses the spool 220 shown in FIG. 1 toward the spring 230. As a result, the communication state and the opening area of the oil port 214 are controlled, and the hydraulic pressure is output proportional to a value of the current which flows in the coil 20.

In the slide core 60 in the present embodiment, the core portion 61 and the magnetic flux transmitting portion 65 are formed integrally with each other. That is, a gap is not provided between the core portion 61 and the magnetic flux transmitting portion 65 in the radial direction. Therefore, when the magnetic circuit is formed by the energization, the distribution of the magnetic flux transmitted from the magnetic flux transmitting portion 65 to the core portion 61 is restricted from being biased in the radial direction. In addition, the distribution of the magnetic flux transmitted from the core portion 61 to the plunger 30 is restricted from being biased in the radial direction. In other words, the magnetic flux density of the magnetic circuit is substantially equal in the circumferential direction. Therefore, generation of side force due to bias of magnetic flux distribution can be restricted.

In the present embodiment, the magnetic flux transmitting portion 65 corresponds to a subordinate concept of a first magnetic flux transmitting portion in the present disclosure, and the ring member 18 corresponds to a subordinate concept of a second magnetic flux transmitting portion in the present disclosure.

In the solenoid 100 in the first embodiment described above, the slide core 60 includes the core portion 61 and the magnetic flux transmitting portion 65. The core portion 61 is formed in a tubular shape and is arranged radially outside the plunger 30. The magnetic flux transmitting portion 65 expands radially outward from the end portion 62 of the core portion 61, and the magnetic flux passes through the magnetic flux transmitting portion 65. That is, the gap is not provided between the core portion 61 and the magnetic flux transmitting portion 65 in the radial direction. Therefore, the distribution of the magnetic flux transmitted from the magnetic flux transmitting portion 65 to the plunger 30 through the core portion 61 can be protected from being biased in the radial direction, and the generation of the side force due to the bias of the magnetic flux distribution can be restricted. Therefore, the slidability of the plunger 30 can be restricted from being deteriorated.

In addition, as a gap is not provided around the end portion 62 of the core portion 61 except the sliding gap, magnetic efficiency can be restricted from being reduced. Furthermore, as the stator core 40 is a single member which integrally includes the magnetic attraction core 50, the slide core 60, and the magnetic flux passage restricting portion 70, the number of the components can be restricted from being increased.

Additionally, as the elastic member 420 biases the stator core 40 toward the bottom 14 of the yoke 10, the magnetic flux transmitting portion 65 can be pressed and brought into contact with the bottom 14. Therefore, the loss of the magnetic flux transmitted from the bottom 14 of the yoke 10 to the magnetic flux transmitting portion 65 can be restricted. In addition, the yoke 10 is formed in a tubular shape with the bottom 14 connected to the side wall 12. Therefore, the yoke 10 can be formed by pressing which is easier than a process in which the bottom 14 is fixed to the side wall 12, after forming the side wall 12 and the bottom 14 separately, to be in contact between the magnetic flux transmitting portion 65 and the bottom 14 by pressing.

When the side wall 12 and the bottom 14 are formed separately from each other, the side wall 12 may be formed by cutting and removing a part corresponding to the bottom 14 after the yoke 10 is formed by pressing. However, in this case, machining accuracy of the side wall 12 may be reduced. Otherwise, the side wall 12 may be formed by cutting and polishing a surface of a tubular member. However, in this case, a manufacturing cost of the side wall 12 may be increased.

In contrast, in the solenoid 100 in the present embodiment, the yoke 10 has a tubular shape with the bottom 14 connected to the side wall 12. Because of this, the yoke 10 can be formed easily by pressing, and the number of the components can be restricted from being large. Additionally, the fixation by the plastic deformation may be omitted. Therefore, a manufacturing process of the yoke 10 can be restricted from being complicated, and an increase in the manufacturing cost of the solenoid 100 can be restricted.

Additionally, the elastic member 420 biases the stator core 40 toward the bottom 14 of the yoke 10. Therefore, when the components of the solenoid 100 are affected by creep in accordance with a temperature rise due to a drive of the solenoid 100, dimensional changes of the components of the solenoid 100 can be absorbed by the elastic force of the elastic member 420. In addition, a pressure load between the magnetic flux transmitting portion 65 and the bottom 14 can be restricted from being reduced. Further, as the elastic member 420 includes the compression spring, the increase in the manufacturing cost of the elastic member 420 can be restricted. In addition, as the elastic member 420 is made of non-magnetic material, a foreign matter made of magnetic material such as iron included in the hydraulic oil can be restricted from being attracted and adhering to the elastic member 420. Because of this, accumulation of the foreign matter is restricted in the elastic member housing portion 218. Therefore, the slidability of the shaft 90 and the plunger 30 can be protected from being deteriorated due to the foreign matter accumulated in the elastic member housing portion 218. Further, the elastic member 420 is made of metal so as to be restricted from reduction in durability. Therefore, reduction in the magnetic efficiency can be restricted as the biasing force of the elastic member 420 can be restricted from being reduced.

The elastic member 420 abuts against the end surface 56 of the magnetic attraction core 50 and is located closer to the spool valve 200 with respect to a position of the magnetic circuit C1. Therefore, reduction in magnetic efficiency can be restricted as the magnetic efficiency is not affected by the elastic member, compared to a structure in which the elastic member is located around magnetic circuit so as to press the magnetic flux transmitting portion to the bottom. In addition, a part of the magnetic flux transmitting portion 65 can be enlarged, or the number of turns of the lead wire in the coil 20 can be increased, compared to the structure in which the elastic member is located around the magnetic circuit C1. Therefore, the magnetic efficiency of the solenoid 100 can be restricted from being reduced.

### B. Second Embodiment

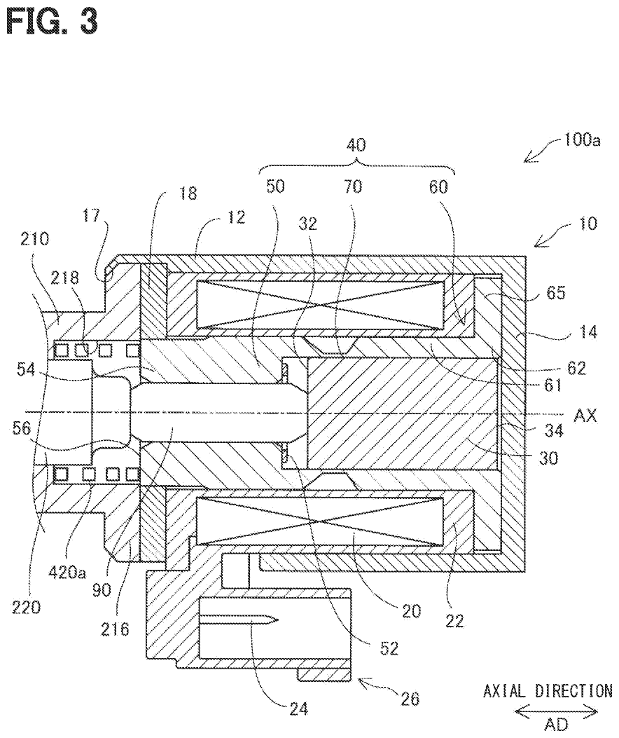

FIG. 3 shows a solenoid 100a in a second embodiment. The solenoid 100a is different from the solenoid 100 in the first embodiment so as to include an elastic member 420a, instead of the elastic member 420. Other structures are similar to those of the solenoid 100 in the first embodiment. Therefore, the same reference numerals are given to the same structures, and the explanation for the structures with the same reference numerals is eliminated.

In the second embodiment, the elastic member 420a included in the solenoid 100a is made of wire which has a rectangle shape in a cross section, such as a square spring. In general, a spring constant of the square spring is larger than that of a spring made of wire which has a round shape in a cross section such as a round spring. Therefore, by using the square spring as the elastic member 420a, a length of the elastic member 420a in the axial direction AD so as to generate a load to bias the stator core 40 toward the bottom 14 can be shorter.

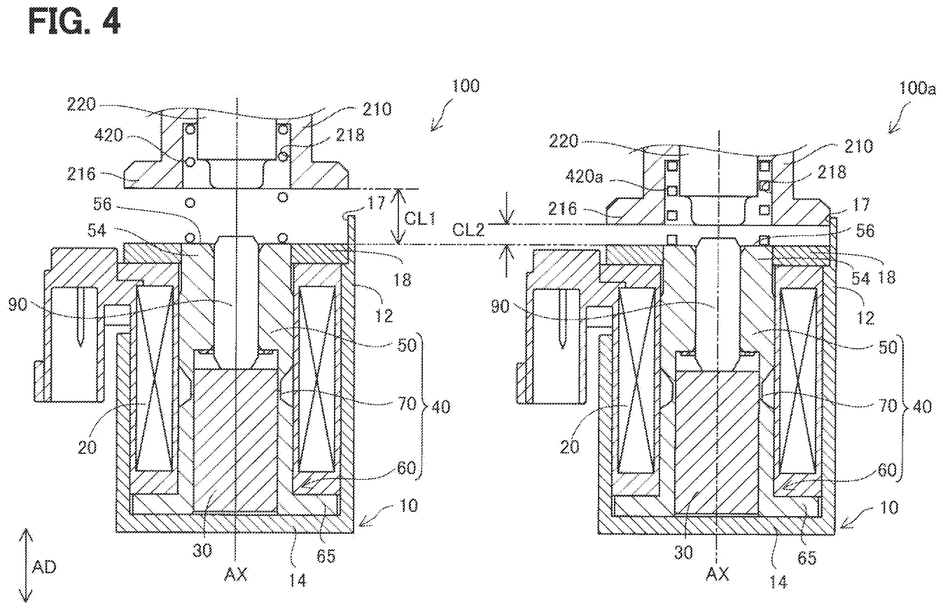

FIG. 4 shows states of the solenoid 100 in the first embodiment and the solenoid 100a in the second embodiment before the solenoid 100, 100a and the spool valve 200 are assembled. A free length of the square spring used as the elastic member 420a of the solenoid 100a in the second embodiment can be shorter than that of the round spring used as the elastic member 420. Therefore, a compression amount CL2 of the square spring during the assembly can be smaller than a compression amount CL1 of the round spring during assembly process.

The solenoid 100a in the second embodiment described above has the same effect as the solenoid 100 in the first embodiment. In addition, as the elastic member 420a is made of wire which has a rectangle shape in a cross section, such as a square spring, the spring constant can be increased. Because of this, the free length of the elastic member 420a can be shorter, and the compression amount CL2 during the assembly process can be smaller. Therefore, workability of the assembly process can be enhanced.

### C. Third Embodiment

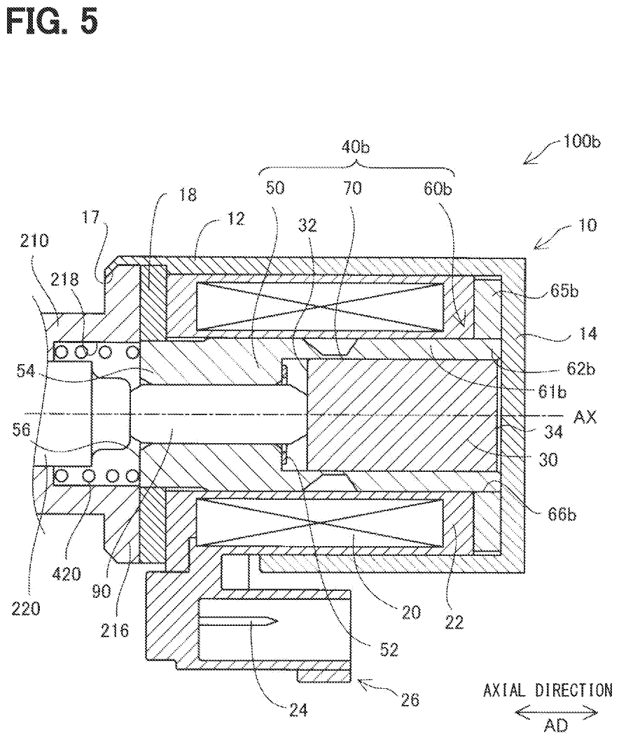

FIG. 5 shows a solenoid 100b in a third embodiment. The solenoid 100b is different from the solenoid 100 in the first embodiment so as to include a stator core 40b instead of the stator core 40. Other structures are similar to those of the solenoid 100 in the first embodiment. Therefore, the same reference numerals are given to the same structures, and the explanation for the structures with the same reference numerals is eliminated.

In the third embodiment, a slide core 60b of the stator core 40b in the solenoid 100b includes a core portion 61b and a magnetic flux transmitting portion 65b which are formed separately from each other. The magnetic flux transmitting portion 65b has a ring shape. Because of this, a through hole 66b is provided in the magnetic flux transmitting portion 65b to extend in the axial direction AD at an inner peripheral side of the magnetic flux transmitting portion 65b in the radial direction. An end portion 62b of the core portion 61b is pressed into the through hole 66b. The core portion 61b and the magnetic flux transmitting portion 65b are assembled by press fitting so as to become an integral structure, and the magnetic flux transmitting portion 65b is fixed to an outer peripheral surface of the end portion 62b of the core portion 61b. Therefore, a gap in the radial direction is approximately not provided between the core portion 61b and the magnetic flux transmitting portion 65b. The core portion 61b may be integrated with the magnetic flux transmitting portion 65b by welding or the like after being inserted into the through hole 66b, not only by the press fitting.

The solenoid 100b in the third embodiment described above has the same effect as the solenoid 100 in the first embodiment. Additionally, the magnetic flux transmitting portion 65b is formed separately from the core portion 61b and includes the through hole 66b. The core portion 61b is inserted into the through hole 66b and is integrated with the magnetic flux transmitting portion 65b. Therefore, a structure of the stator core 40b can be restricted from being complicated, and the increase in the manufacturing cost of the stator core 40b can be restricted.

### D. Fourth Embodiment

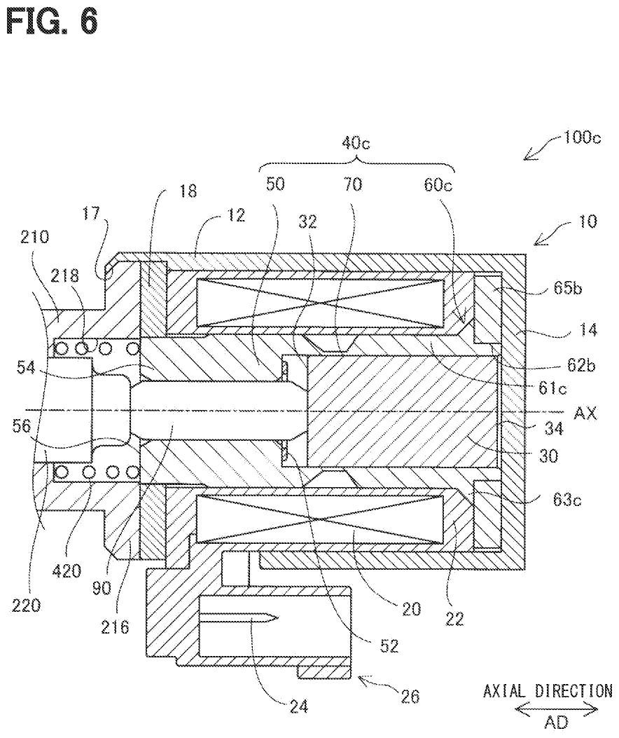

FIG. 6 shows a solenoid 100c in a fourth embodiment. The solenoid 100c is different from the solenoid 100b in the third embodiment in a fixing method of a core portion 61c and the magnetic flux transmitting portion 65b. More specifically, the solenoid 100c in the fourth embodiment includes a stator core 40c instead of the stator core 40b. Other structures are similar to those of the solenoid 100b in the third embodiment. Therefore, the same reference numerals are given to the same structures, and the explanation for the structures with the same reference numerals is eliminated.

A protrusion 63c protrudes radially outward from the core portion 61c of a sliding core 60c in the stator core 40c. By the biasing force of the elastic member 420, the magnetic flux transmitting portion 65b is in contact and pressed between the protrusion 63c and the bottom 14. Because of this, the magnetic flux transmitting portion 65b is fixed to the outer peripheral surface of the end portion 62b of the core portion 61c.

The solenoid 100c in the fourth embodiment described above has the same effect as the solenoid 100b in the third embodiment. In addition, the magnetic flux transmitting portion 65b is fixed to the outer peripheral surface of the end portion 62b of the core portion 61c by the protrusion 63c formed on the core portion 61c of the stator core 40c. Therefore, a process can be omitted to press the core portion 61c and the magnetic flux transmitting portion 65b, and an assembly process of the solenoid 100c can be simplified.

### E. Fifth Embodiment

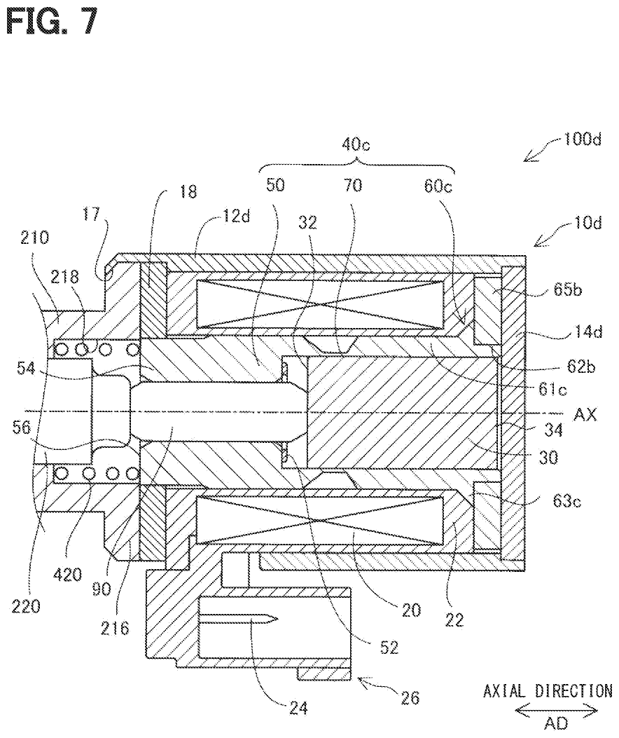

FIG. 7 shows a solenoid 100d in a fifth embodiment. The solenoid 100d is different from the solenoid 100c in the fourth embodiment so as to include a yoke 10d, instead of the yoke 10. Other structures are similar to those of the solenoid 100c in the fourth embodiment. Therefore, the same reference numerals are given to the same structures, and the explanation for the structures with the same reference numerals is eliminated.

In the fifth embodiment, the yoke 10d in the solenoid 100d includes a side wall 12d and a bottom 14d which are formed separately. The bottom 14d has a substantially disk shape and is fixed to the side wall 12d by being pressed onto the side wall 12d.

The solenoid 100d in the fifth embodiment described above has the same effect as the solenoid 100c in the fourth embodiment. In addition, as the bottom 14d is formed separately from the side wall 12d, for example, the bottom 14d can be made of non-magnetic material such as aluminum. Therefore, it is possible to restrict the bottom 14d from generating force attracting the plunger 30.

### F. Sixth Embodiment

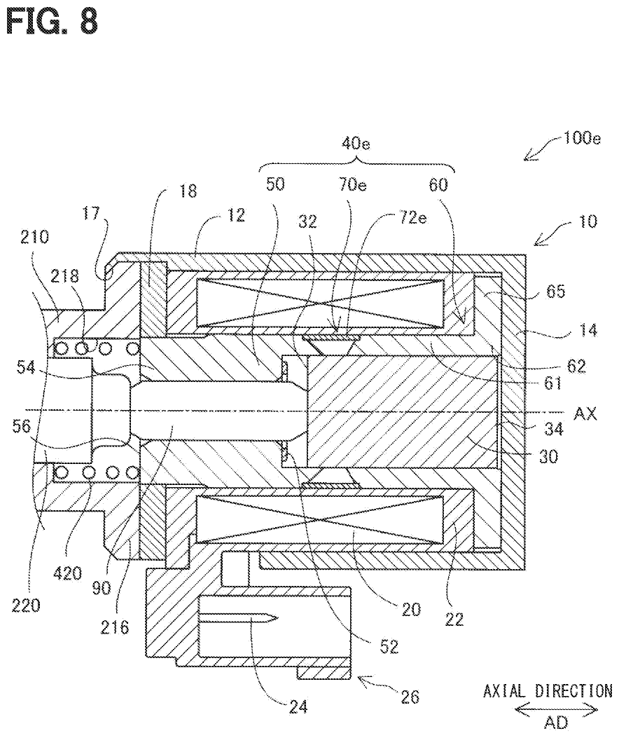

FIG. 8 shows a solenoid 100e in a sixth embodiment. The solenoid 100e is different from the solenoid 100 in the first embodiment so as to include a stator core 40e which includes a magnetic flux passage restricting portion 70e instead of the magnetic flux passage restricting portion 70. Other structures are similar to those of the solenoid 100 in the first embodiment. Therefore, the same reference numerals are given to the same structures, and the explanation for the structures with the same reference numerals is eliminated.

The magnetic flux passage restricting portion 70e of the solenoid 100e in the sixth embodiment includes a connecting portion 72e made of non-magnetic material. The connecting portion 72e physically connects the magnetic attraction core 50 and the slide core 60 which are manufactured separately from each other. In the present embodiment, the connecting portion 72e is thinner than the core portion 61 and physically connects the magnetic attraction core 50 to the slide core 60 in an inner peripheral side of the coil 20. Therefore, a gap is provided between an inner peripheral surface of the connecting portion 72e and an outer peripheral surface of the plunger 30. In the present embodiment, the connecting portion 72e is made of austenitic stainless steel. However, the connecting portion 72e may be made of arbitrary non-magnetic material such as aluminum or brass, not only of the austenitic stainless steel.

The solenoid 100e in the sixth embodiment described above has the same effect as the solenoid 100 in the first embodiment. In addition, the magnetic flux passage restricting portion 70e includes the connecting portion 72e made of non-magnetic material. Therefore, when energized, the magnetic flux is restricted from passing directly from the core portion 61 to the magnetic attraction core 50 without passing through the plunger 30.

### G. Seventh Embodiment

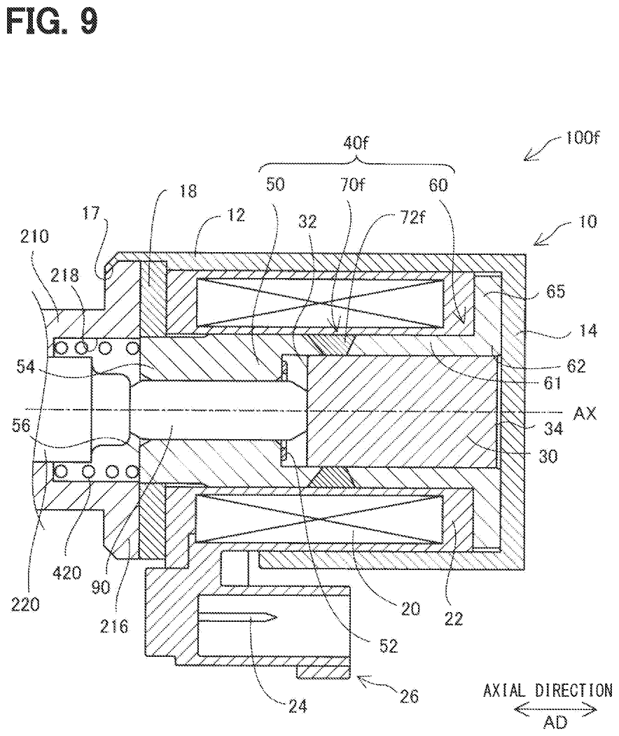

FIG. 9 shows a solenoid 100f in a seventh embodiment. The solenoid 100f is different from the solenoid 100e in the sixth embodiment so as to include a magnetic flux passage restricting portion 70f which includes a connecting portion 72f instead of the connecting portion 72e. Other structures are similar to those of the solenoid 100e in the sixth embodiment. Therefore, the same reference numerals are given to the same structures, and the explanation for the structures with the same reference numerals is eliminated.

The connecting portion 72f in the solenoid 100f in the seventh embodiment has a thickness substantially equal to that of the core portion 61 and is formed by brazing or the like.

The solenoid 100f in the seventh embodiment described above has the same effect as the solenoid 100e in the sixth embodiment. In addition, the connecting portion 72f has the thickness substantially equal to that of the core portion 61. Therefore, the magnetic attraction core 50 and the core portion 61 can be connected more firmly to each other. Further, the connecting portion 72f can also guide a slide of the plunger 30.

### H. Other Embodiments

(1) The configurations of the elastic member 420, 420a in the above embodiments are merely examples and may be modified in various manners. For example, the elastic member 420, 420a may be the compression spring formed in an arbitrary shape such as a substantially cone shape, not only the substantially cylindrical shape. In addition, the elastic member 420, 420a may include an arbitrary elastic member such as a disc spring or a leaf spring, not only the compression spring. When the disc spring is used as the elastic member 420, 420a, the spring constant can be increased compared to that of the compression spring. In addition, the elastic member 420, 420a may be made of resin or the like, not only metal. By such the configuration, effects similar to those in the embodiments described above are also produced.

(2) In the fifth embodiment, the bottom 14d is fixed to the side wall 12d by being pressed into the side wall 12d. However, the bottom 14d may be fixed to the side wall 12d by plastic deformation pressing from the outer side. That is, in general, the bottom may be fixed to the side wall by pressing or by the plastic deformation after being formed separately from the side wall. Effects similar to those in the fifth embodiment are produced also by the configuration described above.

(3) The configurations of the solenoid 100, 100a to 100f in the embodiments described above are merely examples and may be modified in various manners. For example, the plunger 30 is not limited to have a substantially cylindrical shape and may have an arbitrary columnar shape. The core portion 61, 61b, 61c and the side wall 12, 12d of the yoke 10, 10d are not limited to have substantially cylindrical shapes and may have tubular shapes corresponding to the shape of the plunger 30, respectively. In addition, the yoke 10, 10d may have an arbitrary tubular shape with a bottom so as to have a substantially rectangle shape or the like in a cross section, or may have a plate shape which surrounds the coil 20 and the plunger 30, not limited to the tubular shape with the bottom. By such the configuration, effects similar to those in the embodiments described above are also produced.

(4) The solenoid 100, 100a to 100f in the above embodiments is applied to the linear solenoid valve 300 configured to control the hydraulic pressure of the hydraulic oil supplied to the vehicle automatic transmission. In addition, the solenoid 100, 100a to 100f in the above embodiments functions as the actuator configured to drive the spool valve 200. However, the present disclosure is not limited to the above. For example, the solenoid 100, 100a to 100f may be applied to an arbitrary solenoid valve such as an electromagnetic oil passage selector valve of a valve timing control device configured to control valve timing of an intake valve or an exhaust valve for an engine. In addition, for example, the solenoid 100, 100a to 100f may drive an arbitrary valve such as a poppet valve, instead of the spool valve 200, or may drive an arbitrary driven body such as a switch, instead of the valve.

The present disclosure should not be limited to the embodiments described above, and various other embodiments may be implemented without departing from the scope of the present disclosure. For example, the technical features in the embodiments corresponding to the technical features in the form described in the summary may be replaced or combined as appropriate in order to solve a part or all of the issues described above or to achieve a part or all of effects described above. In addition, as long as a technical feature is not described as essential in the present specification, the technical feature may be deleted as appropriate.

What is claimed is:

1. A solenoid comprising:
a coil configured to generate magnetic force when energized;
a plunger formed in a columnar shape, arranged radially inside the coil, and configured to slide in an axial direction;
a yoke that houses the coil and the plunger and includes:
a side wall provided along the axial direction; and
a bottom provided along a direction that intersects the axial direction and opposed to a base end surface of the plunger;
a stator core that includes:
a magnetic attraction core that is opposed to a front end surface of the plunger in the axial direction and configured to magnetically attract the plunger by magnetic force generated by the coil;
a slide core that includes:
a core portion formed in a tubular shape and arranged radially outside the plunger; and
a first magnetic flux transmitting portion fixed to an outer peripheral surface of an end portion of the core portion opposed to the bottom and configured to transmit magnetic flux between the yoke and the plunger through the core portion; and
a magnetic flux passage restricting portion configured to restrict passage of the magnetic flux between the slide core and the magnetic attraction core;
a second magnetic flux transmitting portion arranged radially outside an end portion of the magnetic attraction core located on an opposite side from the plunger in the axial direction and configured to transmit the magnetic flux between the magnetic attraction core and the side wall; and
an elastic member arranged in contact with an end surface of the magnetic attraction core on an opposite side from the plunger in the axial direction and configured to bias the stator core toward the bottom.

2. The solenoid according to claim 1, wherein
the elastic member includes a compression spring.

3. The solenoid according to claim 2, wherein
the compression spring is made of wire which has a rectangle shape in a cross section.

4. The solenoid according to claim 1, wherein
the elastic member includes a disc spring.

5. The solenoid according to claim 1, wherein
the elastic member is made of non-magnetic material.

6. The solenoid according to claim 1, wherein
the first magnetic flux transmitting portion is formed separately from the core portion and includes a through hole, and
the core portion is inserted in the through hole and is integrated with the first magnetic flux transmitting portion.

7. The solenoid according to claim 1, wherein
the core portion includes a protrusion that protrudes radially outward, and
the first magnetic flux transmitting portion is formed separately from the core portion and is pressed in contact with the protrusion and the bottom in the axial direction.

8. The solenoid according to claim 1, wherein
the bottom is formed integrally with the side wall.

9. The solenoid according to claim 1, wherein
the bottom is formed separately from the side wall and is fixed to the side wall by being pressed or by being plastically deformed.

10. The solenoid according to claim 1, wherein
the magnetic flux passage restricting portion includes a connecting portion that is made of non-magnetic material and physically connects the magnetic attraction core to the slide core.
